(19) United States
(12) Patent Application Publication
(10) Pub. No.: US 2026/0350371 A1
(43) Pub. Date: Nov. 5, 2026

(54) CREATION OF USER-EDITABLE LOGIC CIRCUITS IN A VIRTUAL ENVIRONMENT

(71) Applicant: Specs Inc., Santa Clara, CA (US)

(72) Inventors: Daniel Kroymann, Bothell, WA (US); Joshua Wehrly, Seattle, WA (US); Cameron Brown, Seattle, WA (US); Omer Bilal Orhan, Seattle, WA (US); Joshua Gilpatrick, Seattle, WA (US); Benjamin Smith, Bellevue, WA (US)

(21) Appl. No.: 19/668,734

(22) Filed: May 5, 2026

Related U.S. Application Data
(60) Provisional application No. 63/800,310, filed on May 5, 2025.

(51) Int. Cl. G06N 3/0475; G06F 40/40

(52) U.S. Cl. CPC G06N 3/0475; G06F 40/40

(57) ABSTRACT

A computing system for a virtual reality environment is provided. The computing system receives a natural language prompt to add logic to a target virtual object within the virtual environment and uses a generative model to generate text-based logic instructions based on the natural language prompt. The computing system converts the text-based logic instructions to block-based logic instructions and adds the block-based logic instructions to the target virtual object within the virtual environment.

### CROSS-REFERENCE TO RELATED APPLICATION

This patent application claims the benefit of U.S. Provisional Patent Application No. 63/800,310, filed May 5, 2025, which is incorporated by reference herein in its entirety.

### TECHNICAL FIELD

The present disclosure relates generally to virtual reality computing systems and more specifically to authoring of logic for virtual objects.

### BACKGROUND

A head-mounted display can completely occlude a user's visual field and display a virtual environment through which a user can move or be moved. This is typically referred to as Virtual Reality (VR). A head-mounted display can alternatively be implemented with a transparent or semi-transparent display through which a user of the head-mounted display can view the surrounding environment. Such head-mounted displays enable a user to see through the transparent or semi-transparent display to view the surrounding environment, and to also see objects (e.g., objects such as a rendering of a 2D or 3D graphic model, images, video, text, and so forth) that are generated for display to appear as a part of, and/or overlaid upon, the surrounding environment. This is typically referred to as Augmented Reality (AR). In a hybrid form, a view of the surrounding environment is captured using cameras, and then that view is displayed along with augmentation to the user on displays that occlude the user's eyes. Unless the context indicates otherwise, references herein to virtual reality or VR shall be understood to also encompass AR and hybrid implementations of VR and AR.

Virtual environments are often populated with interactive virtual objects whose behavior may be governed by logic authored by users of the virtual environment. The manner in which such logic is authored, applied to virtual objects, and executed in the virtual environment presents a number of technical considerations.

### BRIEF DESCRIPTION OF THE SEVERAL VIEWS OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some non-limiting examples are illustrated in the figures of the accompanying drawings in which:

FIG. 1 is a diagrammatic representation of a networked environment in which the present disclosure may be deployed, according to some examples.

FIG. 2 is a schematic illustration of a generative model workflow for generating block-based logic instructions in response to a voice prompt, according to some examples.

FIG. 3 is a flowchart that illustrates a method of adjusting logic editable within a virtual environment, according to some examples.

FIG. 4 illustrates a circuit graph generation method, according to some examples.

FIG. 5A, FIG. 5B, and FIG. 5C illustrate an example use case of creation of user-editable logic circuits in a virtual environment system, according to some examples.

FIG. 6 is a block diagram that illustrates aspects of a computing device appropriate for use to create a computing system as described in the present disclosure, according to some examples.

### DETAILED DESCRIPTION

Shared virtual reality environments are becoming increasingly popular. While such environments do provide the ability for users to interact with each other, the immersive nature of the environments can be limited if the environments are bare (e.g., plain, undecorated rooms without interactive objects in them). In order to ensure that such environments are filled with objects, content creation tools are sometimes provided within the shared virtual reality environments. These tools not only provide the ability to create detailed locations within the shared virtual environment, but also give users the ability to express their creative desires within the environment.

In some virtual environments, users are given the ability to create logic to be applied to virtual objects. For example, primitive actions (e.g., perform a mathematical function on inputs to generate an output; trigger an event; cause a message to be displayed in the virtual environment; update a characteristic of a virtual object; etc.) may be represented by chips that may be manipulated by a user within the virtual environment. The user may use the virtual environment to connect chips representing these primitive actions together in order to form complex logic, and the connected chips may be assigned to or otherwise attached to a virtual object within the virtual environment.

While these tools have been made available, their functionality tends to be limited by the nature of virtual environment interaction hardware. For example, controllers for interacting with a virtual reality environment are often limited to thumbsticks, buttons, motion trackers, and gaze detection systems. Though these may provide an intuitive way to interact with the environment, their usefulness for detailed object creation and manipulation may be limited, particularly in relation to assigning logic to virtual objects within the environment. Further, while chip-based logic instructions can be manipulated by users within a virtual environment, creating complex logic is impractical due to the cumbersome nature of navigating the interface.

Virtual environments are increasingly presented as shared experiences in which multiple client devices concurrently render a runtime instance of the virtual environment to different participating users. When logic governing the behavior of a virtual object is authored on the fly from natural language input received from one participant and then executed independently on each participating client, the canonical game state observed at different clients can diverge, producing desynchronization, inconsistent outcomes of triggering events, and contradictory representations of the behavior of the virtual object across participants.

Generative models suitable for translating natural language prompts into logic instructions, such as large language models, impose substantial inference-time compute, memory, and storage requirements. Many client devices used to present virtual environments, including head-mounted displays, mobile devices, and game consoles, lack sufficient local resources to host model weights or perform inference locally while concurrently rendering a runtime instance of the virtual environment at interactive frame rates.

Generative model architectures, model providers, and inference infrastructure evolve rapidly. When invocation of a generative model is tightly coupled to the client application or to the agent component that assembles contextual inputs, substituting, upgrading, or scaling the underlying model can require changes to deployed client software, impeding adoption of improved models and complicating version management across a heterogeneous installed base of client devices.

Invocation of a generative model in response to each natural language prompt incurs inference cost and latency. Across a population of users authoring logic for virtual objects, many prompts received from different users describe functionally equivalent behaviors, such that repeated invocation of the generative model produces substantially equivalent logic for substantially equivalent requests, resulting in redundant inference cost and delay between a user's prompt and application of logic to a target virtual object.

Users seeking equivalent behaviors typically express those behaviors using different wording. Two natural language prompts that differ in word choice, word order, inclusion of filler words, or surface phrasing may nonetheless describe the same desired behavior. A retrieval scheme keyed to exact textual match of prior prompts will fail to identify such functionally equivalent prompts as matches, limiting the extent to which previously generated logic can be reused across users.

Logic generated for a particular target virtual object typically references attributes, methods, or sub-objects specific to that target virtual object. A previously generated body of logic that is bound to references specific to a prior target virtual object will not, without further adaptation, operate on a different target virtual object that exposes corresponding but differently named or differently structured attributes, methods, or sub-objects, limiting reuse of previously generated logic across distinct target virtual objects.

Users authoring logic through natural language input frequently wish to refine or extend logic that has been previously applied to a target virtual object, rather than describe a complete behavior from scratch on each request. If a generative model is invoked on each prompt without access to the logic currently bound to the target virtual object, the output of the generative model cannot account for previously generated logic, requiring users to fully restate prior behaviors when requesting refinement.

Computing platforms used to present virtual environments, including console systems and sandboxed application store environments, restrict execution to signed code and do not permit execution of arbitrary unsigned code. Text emitted by a generative model in response to a natural language prompt is unsigned and cannot be executed directly on such platforms, creating a gap between a user's desire to author arbitrary logic through natural language input and the execution constraints imposed by the presenting platform.

Many computing platforms used to present virtual environments, including console systems and sandboxed mobile app store environments, do not permit execution of unsigned code. Text-based logic instructions generated by a large language model in response to a user's natural language prompt are unsigned and therefore cannot be executed directly on such platforms.

In some examples of the present disclosure, a system is provided that generates a virtual reality environment in which a user may use voice prompts to generate logic to be applied to virtual objects within the virtual environment. The system considers context within the virtual environment and can generate logic that manipulates virtual objects within the virtual environment. The system may also use previously generated logic as context for a subsequent voice prompt intended to adjust the logic.

In some examples, a workflow includes compiling the LLM-generated text-based logic instructions into block-based logic instructions whose blocks are implemented by signed code already present within the system. By doing so, a gap can be bridged between platforms that prohibit execution of unsigned code and the user's desire to author complex, arbitrary logic through natural language prompts, allowing AI-generated behavior to run on platforms that would otherwise reject unsigned LLM output.

In some examples of the present disclosure, execution of compiled code corresponding to logic generated from a natural language prompt is performed by a server system under a server authority that maintains a canonical game state for a virtual environment shared among a plurality of participating client devices. Mutations of the canonical game state resulting from execution of the compiled code are effected at the server authority and propagated by the server system to the participating client devices, such that logic authored on the fly from natural language input governs the behavior of a target virtual object consistently across the participating client devices.

In some examples, a VR platform server performs generation of text-based logic instructions using a generative model and compilation of the text-based logic instructions into a circuit graph, while a VR user interface device uploads a scene context to the VR platform server, receives the circuit graph from the VR platform server, and binds the circuit graph to a target virtual object within a runtime instance of the virtual environment. Inference and compilation workloads are hosted at the VR platform server rather than at the VR user interface device, and the VR user interface device participates in authoring of logic for the target virtual object without hosting generative model weights or inference infrastructure locally.

In some examples, the generative model is hosted remotely from an agent of the VR platform server and is invoked through an application programming interface exposed by the remote host, with model selection parameters identifying a particular architecture of the generative model. The generative model is substitutable, upgradable, and scalable independently of the VR platform server and of the VR user interface device by reconfiguring the application programming interface endpoint and the model selection parameters referenced by the agent.

In some examples, the VR platform server stores a circuit graph generated by a compiler from text-based logic instructions in a content library as a cache entry, the cache entry including metadata comprising a representation of the natural language prompt that produced the circuit graph. Upon receipt of a subsequent natural language prompt from a second client device, the VR platform server identifies the cache entry as a cache hit based on a match criterion evaluated between the representation of the natural language prompt in the cache entry and a representation of the subsequent natural language prompt, and the circuit graph is retrieved from the cache entry and transmitted to the second client device for binding to a subsequent target virtual object in place of invocation of the generative model.

In some examples, the representation of the natural language prompt in the metadata of the cache entry comprises a normalized form of the natural language prompt derived by one or more of lowercasing, stop-word removal, lemmatization, or semantic embedding, and the match criterion comprises a similarity measure between semantic embeddings of the normalized forms. A cache entry is identified as a cache hit when the similarity measure exceeds a threshold, notwithstanding differences in wording between the natural language prompt that produced the cache entry and the subsequent natural language prompt.

In some examples, retrieving a cached circuit graph from a cache entry includes rebinding nodes of the cached circuit graph that reference attributes, methods, or sub-objects of a prior target virtual object to corresponding attributes, methods, or sub-objects of a target virtual object identified from a subsequent scene context. A single cached circuit graph representing a particular behavior is thereby applied to different target virtual objects that expose compatible attributes, methods, or sub-objects.

In some examples, a circuit graph currently bound to a target virtual object is serialized into the scene context uploaded to the VR platform server together with a new natural language prompt, and the serialized circuit graph is supplied to the generative model alongside the new natural language prompt as contextual input. The generative model conditions emission of updated text-based logic instructions on the serialized circuit graph, such that the updated text-based logic instructions reflect modifications to, extensions of, or substitutions for, nodes and edges of the existing circuit graph.

In some examples, text-based logic instructions emitted by the generative model are compiled by a compiler of the VR platform server into block-based logic instructions whose blocks are implemented with signed code already present within the system. Logic authored through a natural language prompt is executed on platforms that restrict execution to signed code by invoking the signed code that implements the blocks of the block-based logic instructions, rather than by executing the unsigned text emitted by the generative model.

### Networked Computing Environment

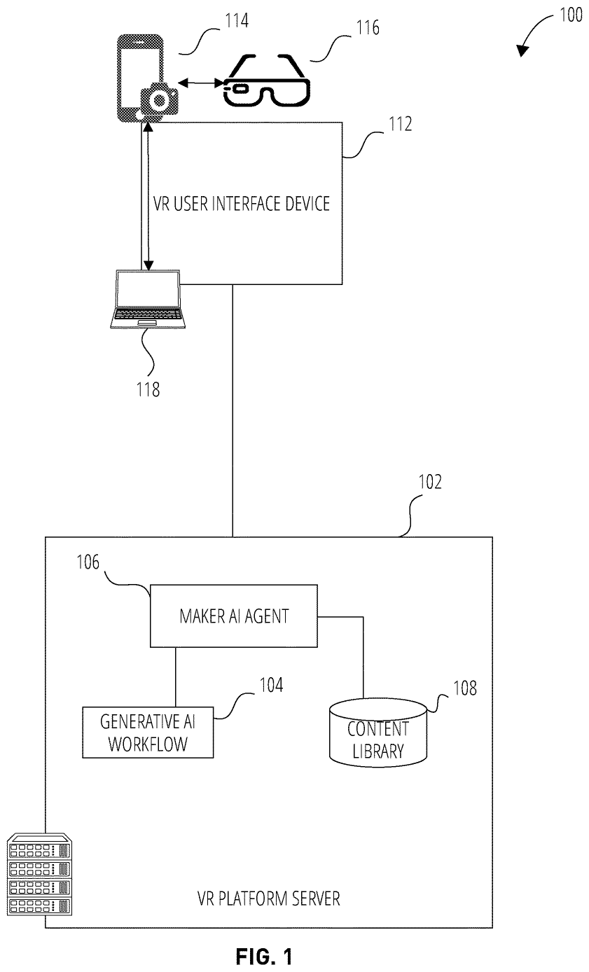

FIG. 1 illustrates a simplified block diagram of a maker Artificial Intelligence (AI) system 100, according to some examples. When a user activates a Maker AI Tool within a VR environment using their VR user interface device 112, a Maker AI Agent 106 receives voice input from the user requesting a change to the virtual environment, such as applying to or modifying logic for a virtual object. A head-mounted display and handheld controllers are one example of interface hardware for interacting with the VR environment. Other types of platforms may include controllers for a game console, a touchscreen interface on a mobile device, or a mouse and keyboard on a desktop computer.

Upon receiving the voice input, the Maker AI Agent 106 provides the voice input along with other contextual information to a generative AI workflow 104. The generative AI workflow 104 may include multiple components that generate a set of block-based logic instructions based on the voice input. The set of block-based logic instructions may then be applied by the Maker AI Agent 106 to a virtual object within the virtual environment, and/or stored within a content library 108 that stores virtual objects for use in the virtual environment.

In some examples, a VR user interface device 112 is communicatively coupled, via one or more networks (e.g., the Internet), to the VR platform server 102. For example, the VR platform server 102 can provide server-side functionality via the network to the VR user interface device 112. While certain functions of the maker AI system 100 are described herein as being performed by either the VR user interface device 112 or by the VR platform server 102, the location of certain functionality either within the VR user interface device 112 or the VR platform server 102 may be a design choice. For example, it may be technically preferable to initially deploy particular technology and functionality within the VR platform server 102 but to later migrate this technology and functionality to the VR user interface device 112 where a VR user interface device 112 has sufficient processing capacity.

In some examples, a VR user interface device 112 may include one or more user devices, such as a mobile device 114, a head-mounted display 116, and a computer 118 that are communicatively connected to exchange data and messages.

In some examples, the VR platform server 102 supports various services and operations that are provided to the VR user interface device 112. Data exchanges within the maker AI system 100 are invoked and controlled through functions available via user interfaces (UIs) of the VR user interface device 112.

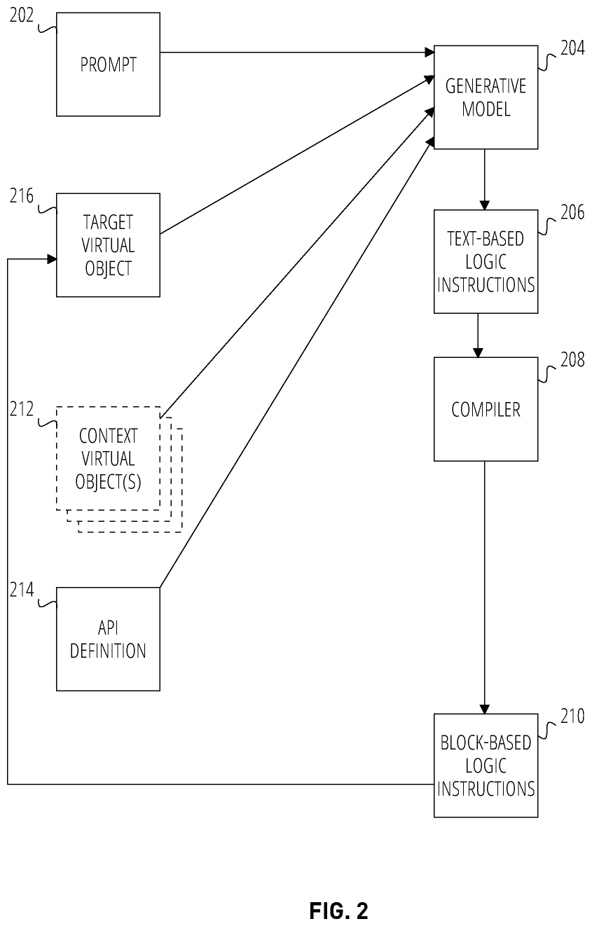

FIG. 2 is a schematic illustration of a of a generative model workflow for generating block-based logic instructions in response to a voice prompt, according to some examples. The generative model 204 is configured to receive a set of inputs that include a prompt 202, a target virtual object 216, one or more optional context virtual objects 212, and an API definition 214. In some examples, the generative model 204 may be a large language model (LLM) having any suitable architecture for generating text-based logic instructions 206, and may include proprietary (via API) or open-source (self-hosted) models. Some non-limiting examples of architectures that may be suitable for use in the generative model 204 include OpenAI GPT4.1, OpenAI o4-mini, DeepSeek R1, Meta Llama 3, and/or Qwen3.

In some examples, the prompt 202 is a voice prompt received via the VR user interface device 112 (of FIG. 1). The prompt 202 describes a behavior or other logic that a user wishes to be applied to the target virtual object 216. Any type of behavior may be requested by the user. Some non-limiting examples of voice prompts that may be provided include:
“Turn this light off when a user presses this switch.”
“Pop up a message when a new user enters the room that shows their name.”
“I want this dog to maintain eye contact with me.”
“This robot should chase me.”
“If this robot gets shot three times, it should explode and then respawn in the corner of the room.”

The target virtual object 216 is data that defines a virtual object to which the generated logic instructions should be applied. The target virtual object 216 may be selected by the Maker AI Agent 106 based on cues within the prompt 202. For example, the prompt 202 might include a statement such as, “make this object do something.” The Maker AI Agent 106 may determine a virtual object that is likely to be the virtual object to which the user is referring based on whether a virtual object has been selected by the user within the virtual environment, whether a gaze location or a pointer of the user is directed at a specific virtual object, or using any other suitable technique.

In some examples, the target virtual object 216 provided to the generative model 204 may include one or more attributes of the target virtual object 216, and/or one or more methods or functions that may be executed by the target virtual object 216. In some examples, the target virtual object 216 may be a container that includes various sub-objects. For example, a target virtual object 216 that represents a user avatar may include a sub-object for a head, a sub-object for a left arm, a sub-object for a right arm, etc. In some examples, the definition of the target virtual object 216 provided to the generative model 204 may include variable names, comments, or other descriptions regarding the purpose of each attribute and/or method, in order to provide information to the generative model 204 regarding the effects of adjusting each attribute and/or calling each method.

The API definition 214 is a text-based definition of one or more logical actions that are supported by the system. Each logical action may be defined by a function signature, similar to a header file for an application programming interface (API). In some examples, the text-based definition of a given logical action may include a function name, a set of inputs (including input names and data types), a set of outputs (including output names and data types), a triggering event, and/or other characteristics of a logical step. In some examples, the text-based definition may include comments or other text that provides information to the generative model 204 regarding the purpose of each logical action. Each logical action defined in the API definition 214 typically represents a type of available block in the block-based logic instructions supported by the VR platform server 102. Any types of actions may be supported. For example, some logical actions may be simple primitive actions (e.g., add two values, subtract two values, display a string to the user, etc.), while other logical actions may provide more complex behavior (e.g., trigger an action, move an object to a given location in the virtual environment, adjust an attribute of a virtual object, etc.).

The context virtual objects 212 include data that defines other virtual objects within a scene that may be relevant to the instructions to be created. For example, the virtual environment may present a scene to the user in which the user is in a room with various other virtual objects in addition to the target virtual object 216. The other virtual objects within the room, as well as virtual objects that make up the room (e.g., walls, lighting sources, etc.) may be provided to the generative model 204 as context virtual objects 212.

Once the generative model 204 receives the inputs, the generative model 204 generates text-based logic instructions 206. The text-based logic instructions 206 may be in C#, Python, or any other suitable text-based programming language that can represent the logical primitives provided by the logical blocks of the system. By using the generative model 204 to output text-based logic instructions 206, readily available architectures for outputting text-based programming content may be used instead of attempting to create a generative model 204 that directly outputs block-based logic. Further, by providing the API definition 214 as context to the generative model 204, the output of the generative model 204 can be limited to actions that can be invoked using supported block-based logic instructions.

The text-based logic instructions 206 are then provided to a compiler 208. The compiler 208 may use common compilation techniques (e.g., lexing, parsing, etc.) to build a representation of the text-based logic instructions 206, and may then output a set of block-based logic instructions 210 based on that representation. Because the text-based logic instructions 206 are limited to primitive operations supported by the block-based logic instructions 210, the compiler 208 can use heuristic rules to convert the representation of the text-based logic instructions 206 directly to the block-based logic instructions 210. In some examples, the block-based logic instructions 210 may be represented as object definitions (e.g., JSON objects that specify data types and attributes) that may be rendered visually in the virtual environment and executed within the virtual environment.

The block-based logic instructions 210 are then applied to the target virtual object 216. in some examples, the block-based logic instructions 210 may be saved by the Maker AI Agent 106 in the content library 108 along with the definition of the target virtual object 216.

Upon receiving a subsequent request to present the target virtual object 216, the VR platform server 102 presents the target virtual object 216 and applies the logic represented by the block-based logic instructions 210. The VR platform server 102 may subsequently receive a request via the VR user interface device 112 to present the block-based logic instructions 210, at which point the VR platform server 102 will render the block-based logic instructions 210 within the virtual environment. The VR platform server 102 may receive edits to the block-based logic instructions 210 via the VR user interface device 112 within the virtual environment, and may save the edited block-based logic instructions 210 in the content library 108. Accordingly, the use of a generative AI workflow 104 to generate block-based logic instructions 210 can allow complex logic to be generated and applied to virtual objects while still allowing interaction with and editing of the logic within the virtual environment by representing the complex logic with block-based logic instructions 210, even if creating the block-based logic instructions 210 from scratch within the virtual environment would be impractical.

In some examples, the generative AI workflow 104 may use context from one or more previous executions of the generative AI workflow 104. As shown, the block-based logic instructions 210 are applied to the target virtual object 216. The VR platform server 102 may receive a subsequent voice prompt via the VR user interface device 112 that suggests an amendment to the logic that was applied to the target virtual object 216. Since the previous logic will be provided along with the target virtual object 216 as input to the generative model 204, the generative model 204 may consider the previously generated logic in responding to the subsequent prompt. In some examples, the text-based logic instructions 206 generated in a previous iteration may be saved as context, and may be provided as an additional input to the generative model 204 for a subsequent iteration.

In addition to the benefits obtained by being able to overcome the impracticality of manually creating complex logic using block-based logic instructions from scratch, examples of the present disclosure also provide technical improvements in avoiding problems in computer security. In many computing platforms that may be used to present the virtual environment (e.g., a console system such as an Xbox, PlayStation, or Switch; a sandboxed app store environment such as the iOS app store; etc.), the computing platform may not allow the execution of unsigned code (such as text-based logic instructions that would be generated by an LLM). The workflow illustrated in FIG. 2 helps bridge the gap between platforms that do not allow the execution of unsigned code and the user's desire to provide complex, arbitrary logic for virtual objects, in that even though the LLM generates unsigned code, this unsigned code is then compiled into block-based logic instructions 210 that are implemented with signed code that is already present within the system.

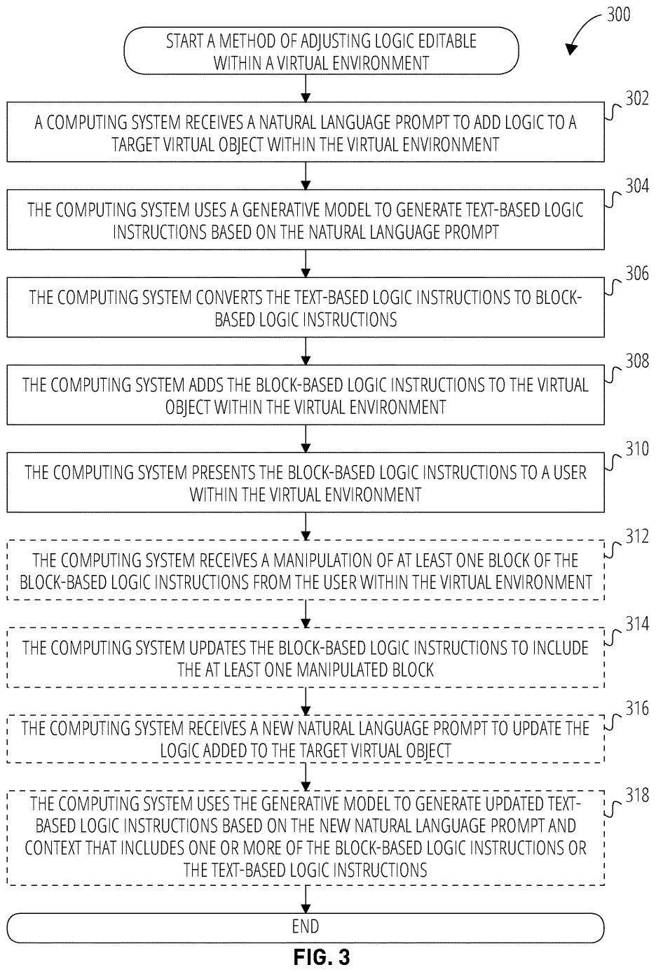

FIG. 3 is a flowchart that illustrates a non-limiting example of a method 300 of adjusting logic editable within a virtual environment, according to some examples.

From a start block, the method 300 proceeds to block 302, where a computing system receives a natural language prompt 202 (of FIG. 2) to add logic to a target virtual object 216 (of FIG. 2) within the virtual environment. The natural language prompt 202 may be a voice prompt received via the VR user interface device 112 (of FIG. 1), and may describe a behavior or other logic that a user wishes to be applied to the target virtual object 216. The target virtual object 216 may be selected by the Maker AI Agent 106 (of FIG. 1) based on cues within the prompt 202, such as whether a virtual object has been selected by the user within the virtual environment, whether a gaze location or a pointer of the user is directed at a specific virtual object, or using any other suitable technique.

At block 304, the computing system uses a generative model 204 (of FIG. 2) to generate text-based logic instructions 206 (of FIG. 2) based on the natural language prompt 202. In some examples, the generative model 204 is a large language model (LLM), which may be proprietary (via API) or open-source (self-hosted). The generative model 204 may receive, in addition to the prompt 202, contextual inputs that include the target virtual object 216, one or more optional context virtual objects 212 (of FIG. 2), and an API definition 214 (of FIG. 2). The API definition 214 is a text-based definition of one or more logical actions that are supported by the system, wherein each logical action defined in the API definition 214 typically represents a type of available block in the block-based logic instructions supported by the VR platform server 102 (of FIG. 1). The context virtual objects 212 include data that defines other virtual objects within a scene that may be relevant to the instructions to be created, such as other virtual objects within a room in which the target virtual object 216 is located or virtual objects that make up the room itself. The text-based logic instructions 206 may be in C#, Python, or any other suitable text-based programming language that can represent the logical primitives provided by the logical blocks of the system. By using the generative model 204 to output text-based logic instructions 206, readily available architectures for outputting text-based programming content may be used instead of attempting to create a generative model 204 that directly outputs block-based logic; further, by providing the API definition 214 as context to the generative model 204, the output of the generative model 204 can be limited to actions that can be invoked using supported block-based logic instructions.

At block 306, the computing system converts the text-based logic instructions 206 to block-based logic instructions 210 (of FIG. 2). The conversion may be performed by a compiler 208 (of FIG. 2) that uses common compilation techniques (e.g., lexing, parsing, etc.) to build a representation of the text-based logic instructions 206, and that then outputs a set of block-based logic instructions 210 based on that representation. Because the text-based logic instructions 206 are limited to primitive operations supported by the block-based logic instructions 210, the compiler 208 can use heuristic rules to convert the representation of the text-based logic instructions 206 directly to the block-based logic instructions 210. In some examples, the block-based logic instructions 210 may be represented as object definitions (e.g., JSON objects that specify data types and attributes) that may be rendered visually in the virtual environment and executed within the virtual environment.

At block 308, the computing system adds the block-based logic instructions 210 to the target virtual object 216 within the virtual environment. In some examples, the block-based logic instructions 210 may also be saved by the Maker AI Agent 106 in the content library 108 (of FIG. 1) along with the definition of the target virtual object 216, such that upon a subsequent request to present the target virtual object 216, the VR platform server 102 presents the target virtual object 216 and applies the logic represented by the block-based logic instructions 210.

At block 310, the computing system presents the block-based logic instructions 210 to a user within the virtual environment. In some examples, the computing system may also execute the block-based logic instructions 210 to apply behavior to the target virtual object 216. Representing the complex logic generated by the generative model 204 as block-based logic instructions 210 allows complex logic to be generated and applied to virtual objects while still allowing interaction with and editing of the logic within the virtual environment, even if creating the block-based logic instructions 210 from scratch within the virtual environment would be impractical. Additionally, because many computing platforms that may be used to present the virtual environment may not allow the execution of unsigned code (such as text-based logic instructions that would be generated by an LLM), compiling the text-based logic instructions 206 into block-based logic instructions 210 that are implemented with signed code already present within the system bridges the gap between such platforms and the user's desire to provide complex, arbitrary logic for virtual objects.

At optional block 312, the computing system receives a manipulation of at least one block of the block-based logic instructions 210 from the user within the virtual environment, and at optional block 314, the computing system updates the block-based logic instructions 210 to include the at least one manipulated block. The actions of optional block 312 and optional block 314 are described as optional because in some examples, the block-based logic instructions 210 may be applied to the target virtual object 216 without receiving any manipulations thereof.

At optional block 316, the computing system receives a new natural language prompt 202 to update the logic added to the target virtual object 216. At optional block 318, the computing system uses the generative model 204 to generate updated text-based logic instructions 206 based on the new natural language prompt 202 and context that includes one or more of the block-based logic instructions 210 or the text-based logic instructions 206. Because the previously generated logic is provided along with the target virtual object 216 as input to the generative model 204, the generative model 204 may consider the previously generated logic in responding to the subsequent prompt; in some examples, the text-based logic instructions 206 generated in a previous iteration may be saved as context and provided as an additional input to the generative model 204 for a subsequent iteration. The actions of optional block 316 and optional block 318 are described as optional because in some examples, the block-based logic instructions 210 may be applied to the target virtual object 216 without receiving a new natural language prompt 202 to update the logic.

The method 300 then proceeds to an end block and terminates.

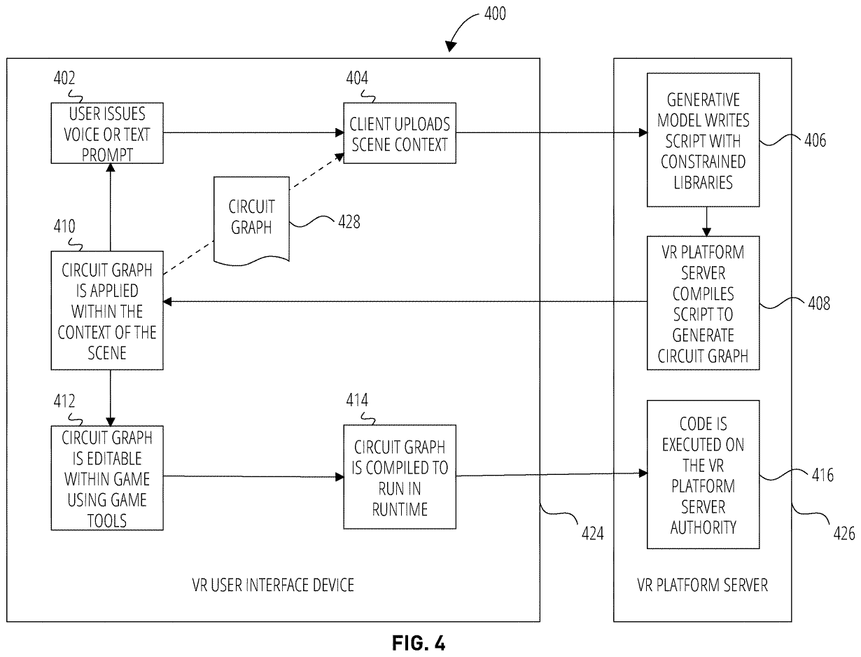

FIG. 4 illustrates a circuit graph generation method 400, according to some examples. A VR user interface device 424 and a VR platform server 426 use the circuit graph generation method 400 to coordinate generation and use of a circuit graph 428 during a runtime of a virtual environment. Although the example circuit graph generation method 400 depicts a particular sequence of operations, the sequence may be altered without departing from the scope of the present disclosure. For example, some of the operations depicted may be performed in parallel or in a different sequence that does not materially affect the function of the circuit graph generation method 400. In other examples, different components of an example device or system that implements the circuit graph generation method 400 may perform functions at substantially the same time or in a specific sequence.

In some examples, at block 402, the user issues voice prompt or a text prompt from within the virtual environment while using the VR user interface device 424. For example, the voice prompt or text prompt is issued from within a runtime instance of the virtual environment that is presented to the user by the VR user interface device 424, such that input capture occurs concurrently with rendering of the virtual environment to the user. In some examples, the voice prompt is captured by an audio input component of the VR user interface device 424, such as a microphone, and the text prompt is captured by an alphanumeric input component of the VR user interface device 424, such as a keyboard, a touch screen configured to receive alphanumeric input, or a photo-optical keyboard, or a virtual keyboard that is a component of the virtual environment.

In some examples, the voice prompt or the text prompt describes a behavior or other logic that the user wishes to be applied to a target virtual object within the virtual environment, with non-limiting examples of voice prompts including phrases such as “Turn this light off when a user presses this switch,” “Pop up a message when a new user enters the room that shows their name,” or “This robot should chase me.”

In some examples, the VR user interface device 424 is implemented as one or more user devices including a head-mounted display, a mobile device with a touchscreen interface, a game console with handheld controllers, or a desktop computer with a mouse and keyboard, any of which supports presentation of the virtual environment to the user and capture of the voice prompt or the text prompt during runtime of the virtual environment.

In some examples, at block 404, the VR user interface device 424 uploads a scene context to the VR platform server 426. For example, the scene context is assembled by the VR user interface device 424 from data representing a runtime state of the virtual environment presented to the user, and is transmitted over a network from the VR user interface device 424 to the VR platform server 426 using a network interface component of the VR user interface device 424.

In some examples, the scene context includes data defining one or more context virtual objects 212 (of FIG. 2) that are present within a scene of the virtual environment, such as other virtual objects within a room in which a target virtual object 216 (of FIG. 2) is located and virtual objects that make up the room, including walls and lighting sources. The scene context may further include data defining the target virtual object 216, including one or more attributes of the target virtual object 216, one or more methods or functions executable by the target virtual object 216, and, where the target virtual object 216 is a container, definitions of sub-objects of the target virtual object 216.

In some examples, the scene context includes cues usable by a Maker AI Agent 106 (of FIG. 1) of the VR platform server 426 to identify the target virtual object 216 from among the context virtual objects 212, such as an indication that a particular virtual object has been selected by the user within the virtual environment, a gaze location of the user, or a pointer direction of the user. The scene context may also include a text-based application programming interface (API) definition 214 (of FIG. 2) identifying logical actions supported by the VR platform server 426, or a reference by which the VR platform server 426 retrieves the API definition 214 from a content library 108 (of FIG. 1).

In some examples, the scene context is uploaded in a structured data format, such as one or more JSON objects that specify data types and attributes for the context virtual objects 212 and the target virtual object 216, and the upload is performed in association with the voice prompt or the text prompt such that the VR platform server 426 receives the scene context together with the prompt for subsequent processing.

In some examples, at block 406, the VR platform server 426 uses a generative model of the VR platform server 426 to generate a script based on the prompt, the scene context, and constrained libraries. For example, the generative model is implemented as a generative model 204 (of FIG. 2) comprising a large language model (LLM) having an architecture configured to generate text-based output, and is hosted on the VR platform server 426 as either a proprietary model accessed via an API or an open-source self-hosted model such as OpenAI GPT4.1, OpenAI o4-mini, DeepSeek R1, Meta Llama 3, or Qwen3. In some examples, the generative model 204 receives the voice prompt or the text prompt together with the scene context as contextual inputs, and emits the script as text-based logic instructions 206 (of FIG. 2) written in C#or another text-based programming language that represents logical primitives supported by the VR platform server 426. In some examples, the constrained libraries are defined by the API definition 214 identifying function signatures, function names, input and output data types, and triggering events for logical actions supported by the VR platform server 426, such that the output of the generative model 204 is bounded to invocations of the constrained libraries and is prevented from referencing functions outside of the API definition 214. In some examples, the target virtual object 216 and the context virtual objects 212 extracted from the scene context are supplied to the generative model 204 alongside the API definition 214, allowing the generative model 204 to emit statements within the script that reference attributes, methods, or sub-objects of the target virtual object 216 as exposed by the constrained libraries.

In some examples, at block 408, the VR platform server 426 compiles the script to generate a circuit graph 428. For example, the script emitted by the generative model 204 is provided as input to a compiler 208 (of FIG. 2) executing on the VR platform server 426, and the compiler 208 applies lexing and parsing techniques to tokenize the C#source text and build an intermediate representation of the statements, expressions, and invocations contained in the script.

In some examples, the compiler 208 traverses the intermediate representation and applies heuristic rules that map each invocation of a constrained library function within the script to a corresponding node of the circuit graph 428, such that each logical action referenced in the script is translated into a graph node exposing the inputs, outputs, and triggering events defined for that action in the API definition 214. In some examples, connections between nodes of the circuit graph 428 are generated by the compiler 208 based on data-flow relationships between the outputs and inputs of successive function invocations in the script, and based on control-flow constructs in the script that map to triggering events of the logical actions.

In some examples, the circuit graph 428 is emitted by the compiler 208 as a set of object definitions, such as JSON objects that specify, for each node, a node type corresponding to a logical action from the API definition 214, values or references for input parameters, and edges identifying connected nodes, such that the circuit graph 428 is renderable within the virtual environment and executable by the VR platform server 426. In some examples, the circuit graph 428 is associated by the VR platform server 426 with the target virtual object 216 identified in the scene context, such that the nodes of the circuit graph 428 reference attributes, methods, or sub-objects of the target virtual object 216 as operands for the logical actions represented by those nodes.

In some examples, at block 410, the VR user interface device 424 applies the circuit graph 428 within the context of the virtual environment. For example, the circuit graph 428 generated by the VR platform server 426 is transmitted from the VR platform server 426 over the network to the VR user interface device 424, and is received by the VR user interface device 424 as a set of object definitions specifying nodes, input parameter values, and edges that identify connected nodes. In some examples, the VR user interface device 424 binds the received circuit graph 428 to the target virtual object 216 within the runtime instance of the virtual environment presented to the user, such that the nodes of the circuit graph 428 are associated with attributes, methods, or sub-objects of the target virtual object 216 as operands for the logical actions represented by those nodes.

In some examples, the VR user interface device 424 renders a visual representation of the circuit graph 428 within the virtual environment, such that the nodes and edges of the circuit graph 428 are displayed to the user as connected block elements positioned in proximity to the target virtual object 216 or within a dedicated editing region of the virtual environment. In some examples, the circuit graph 428 is applied by the VR user interface device 424 such that the triggering events defined for each node of the circuit graph 428 are registered with event sources of the target virtual object 216 and the context virtual objects 212 within the scene, allowing events occurring within the scene, such as user interactions with a switch or entry of a new user into a room, to invoke corresponding nodes of the circuit graph 428.

In some examples, the VR user interface device 424 displays a confirmation message within the virtual environment in association with the target virtual object to indicate to the user that the circuit graph 428 has been applied, and the VR user interface device 424 continues to present the virtual environment with the circuit graph 428 bound to the target virtual object so that subsequent runtime events propagate through the nodes and edges of the circuit graph 428 in accordance with the data-flow and control-flow relationships established by the compiler 208.

In some examples, at block 412, the VR user interface device 424 makes the circuit graph 428 available as editable within the virtual environment using game tools. For example, the VR user interface device 424 exposes the nodes and edges of the circuit graph 428 as manipulable block elements within the virtual environment, such that input devices of the VR user interface device 424, including handheld controllers, a touchscreen interface, a mouse and keyboard, or motion trackers, are used to select, reposition, connect, disconnect, or parameterize individual nodes of the circuit graph 428.

In some examples, the game tools include a block-manipulation interface that is rendered within the runtime instance of the virtual environment alongside the circuit graph 428, and that provides affordances for adding new blocks drawn from logical actions defined in the API definition 214, deleting blocks, editing input parameter values associated with nodes of the circuit graph 428, and drawing or severing edges between outputs and inputs of nodes to alter data-flow relationships between nodes.

In some examples, the game tools operate on the circuit graph 428 while the circuit graph 428 remains bound to the target virtual object 216, such that a manipulation received through the game tools updates the object definitions of the circuit graph 428 in place and the updated circuit graph 428 continues to be associated with the attributes, methods, or sub-objects of the target virtual object 216 referenced by the affected nodes.

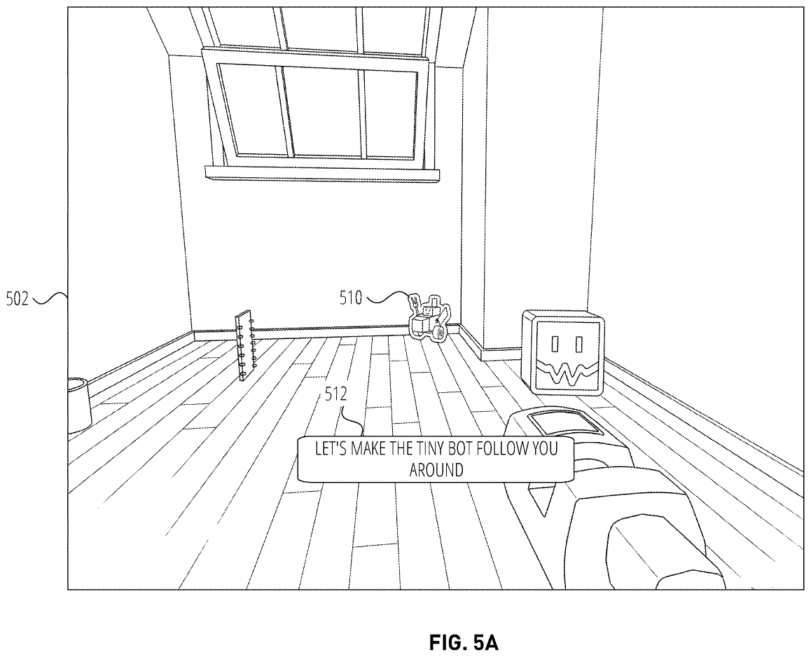

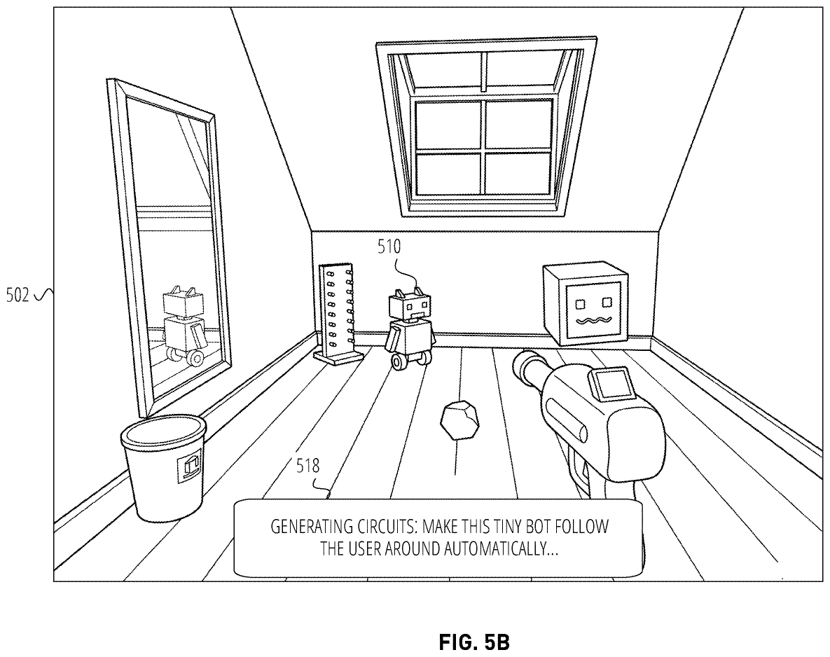

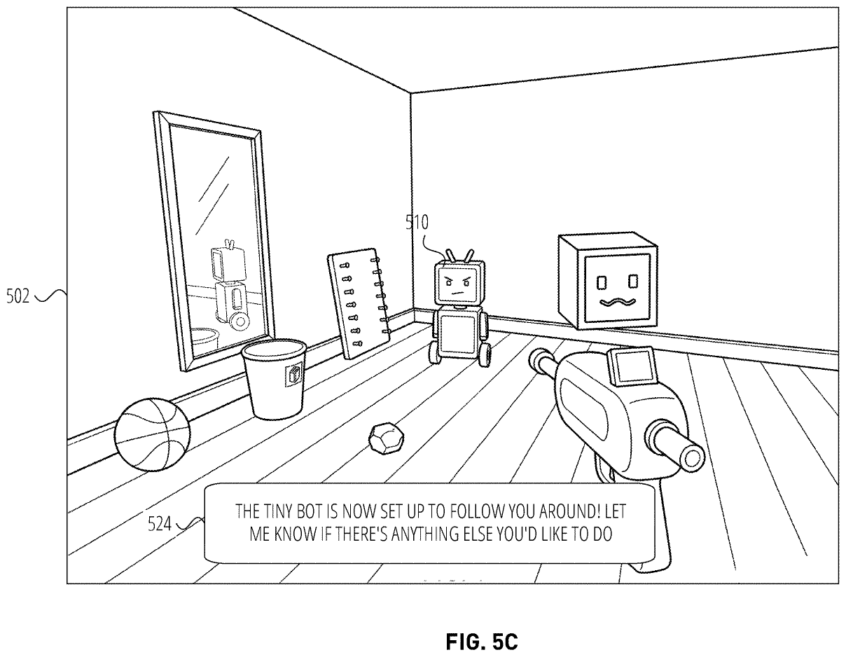

In some examples, the VR user interface device 424 displays a status message 518 (of FIG. 5B) within the virtual environment 502 in association with the target virtual object 510 during editing of the circuit graph 428 to indicate to the user that the circuit graph 428 is available for manipulation, and the game tools permit iterative modification of the circuit graph 428 by the user without requiring regeneration of the circuit graph 428 by the generative model 204.

In some examples, the circuit graph 428 can be edited using the processes of block 302 and block 304 as the circuit graph 428 is included in the scene context that is provided to the VR platform server 426 during the circuit graph 428 creation process. For example, when a new natural language prompt is received via the VR user interface device 424 to update the logic previously applied to the target virtual object 216, the circuit graph 428 currently bound to the target virtual object 216 is serialized by the VR user interface device 424 into the scene context uploaded to the VR platform server 426, such that the nodes, edges, input parameter values, and triggering events of the circuit graph 428 are included alongside the definitions of the target virtual object 216 and the context virtual objects 212. In some examples, the scene context containing the serialized circuit graph 428 is supplied together with the new natural language prompt as contextual inputs to the generative model 204, in a manner consistent with the operations of block 302 at which a computing system receives a natural language prompt 202 (of FIG. 2) and block 304 at which the computing system uses the generative model 204 to generate text-based logic instructions 206 (of FIG. 2). In some examples, the generative model 204 uses the serialized circuit graph 428 included in the scene context as feedback context that conditions the emission of updated text-based logic instructions 206, such that the updated text-based logic instructions 206 reflect modifications to, extensions of, or substitutions for, nodes and edges of the existing circuit graph 428 rather than describing logic generated from scratch. In some examples, the updated text-based logic instructions 206 emitted by the generative model 204 are then subject to the processes of block 408 and block 410 to produce an updated circuit graph 428 that replaces or augments the prior circuit graph 428 bound to the target virtual object 216 within the virtual environment.

In some examples, an implementation of the virtual environment includes maintaining a shared game state across multiple participating VR user interface devices. In such implementations, the VR user interface device 424 compiles the circuit graph to run in a runtime and provides the resulting compiled code to the VR platform server 426 for execution under a server authority to enforce a consistent canonical game state observable by each participating client. For example, at block 414, the VR user interface device 424 compiles the circuit graph 428 to run in the runtime instance of the virtual environment. For example, the circuit graph 428 bound to the target virtual object 216 is passed as input to a client-side compilation component of the VR user interface device 424, which traverses the nodes and edges of the circuit graph 428 and emits executable instructions that correspond to the logical actions defined by the node types and to the data-flow and control-flow relationships represented by the edges.

In some examples, the executable instructions emitted by the client-side compilation component are generated as intermediate language instructions suitable for execution by a runtime, such as, but not limited to, a Mono runtime of a Unity platform or the like, used to develop and present the virtual environment, such that the circuit graph 428 is transformed from a declarative graph representation into a procedural form that is loadable and dispatchable by the runtime during the runtime instance of the virtual environment.

In some examples, the runtime hosted by the VR user interface device 424 loads the compiled instructions and registers the triggering events of the nodes of the circuit graph 428 with event sources of the target virtual object 216 and the context virtual objects 212, such that an occurrence of a triggering event within the runtime instance of the virtual environment causes the runtime to invoke corresponding compiled routines that implement the logical actions represented by the nodes of the circuit graph 428.

In some examples, the compilation performed by the VR user interface device 424 validates that each node of the circuit graph 428 references a logical action defined in the API definition 214 and that input parameter values for each node conform to input data types specified by the API definition 214 before the runtime executes the compiled routines, such that execution by the runtime is constrained to the signed logical actions exposed by the VR platform server 426.

In some examples, at block 416, the VR platform server 426 executes the compiled code on the server authority. For example, the compiled code produced at block 414 is received by the VR platform server 426 from the VR user interface device 424 over the network, and is loaded into a runtime hosted by the VR platform server 426 that serves as the server authority for the runtime instance of the virtual environment.

In some examples, the server authority is a designated process that maintains a canonical game state for the virtual environment shared among multiple participating VR user interface devices, and execution of the compiled code by the server authority causes mutations of the canonical game state, including updates to attributes of the target virtual object 216 and of the context virtual objects 212, to occur only at the server authority so that the canonical game state remains consistent across the participating VR user interface devices.

In some examples, the server authority dispatches the compiled code in response to occurrences of triggering events registered for the nodes of the circuit graph 428, such that an event observed within the runtime instance of the virtual environment, such as a user interaction with a switch or entry of a new user into a room, is propagated from the VR user interface device 424 to the VR platform server 426 and invokes the corresponding compiled routines under the server authority. The compiled routines executed under the server authority read input parameter values from the canonical game state, compute outputs in accordance with the data-flow relationships represented by the edges of the circuit graph 428, and write results back to the canonical game state.

In some examples, the VR platform server 426 broadcasts state updates resulting from execution of the compiled code under the server authority to the VR user interface device 424 and to other participating VR user interface devices, such that a representation of the canonical game state presented at each participating VR user interface device reflects the results of the compiled routines executed under the server authority. In some examples, execution of the compiled code by the server authority is confined to invocations of logical actions defined in the API definition 214, such that only signed logical actions exposed by the VR platform server 426 are dispatched as part of execution at block 416.

In some examples, the VR platform server 102 maintains a cache of previously generated circuit graphs 428 such that, in response to a subsequent natural language prompt 202 received via the VR user interface device 112 to add logic to a target virtual object 216, the VR platform server 102 retrieves a cached circuit graph 428 produced by a prior invocation of the generative model 204 and applies the retrieved circuit graph 428 to the target virtual object 216 in place of invoking the generative model 204 to freshly generate text-based logic instructions 206. For example, upon generation of a circuit graph 428 by the compiler 208 of the VR platform server 102 from text-based logic instructions 206 emitted by the generative model 204, the VR platform server 102 stores the circuit graph 428 in the content library 108 as a cache entry, the cache entry including the object definitions of the circuit graph 428 and associated metadata by which the cache entry can be retrieved in response to subsequent natural language prompts 202.

In some examples, the metadata stored with the cache entry includes a representation of the natural language prompt 202 that produced the circuit graph 428, a representation of the scene context supplied to the generative model 204 during generation of the circuit graph 428, a representation of the target virtual object 216 to which the circuit graph 428 was applied, and a representation of the API definition 214 under which the circuit graph 428 was produced. In some examples, the representation of the natural language prompt 202 stored with the cache entry includes a normalized form of the natural language prompt 202 derived by one or more of lowercasing, stop-word removal, lemmatization, or semantic embedding, such that the normalized form provides a basis for matching the cache entry to subsequently received natural language prompts 202 that differ lexically from the natural language prompt 202 that produced the cache entry but describe an equivalent behavior.

In some examples, upon receipt of a subsequent natural language prompt 202 via the VR user interface device 112, the VR platform server 102 computes a normalized form of the subsequent natural language prompt 202 using a same procedure as was used to derive the normalized forms stored in the cache entries of the content library 108, and queries the content library 108 for cache entries having normalized forms that satisfy a match criterion with respect to the normalized form of the subsequent natural language prompt 202. In some examples, the match criterion is implemented as a similarity measure between semantic embeddings of the normalized forms, such that a cache entry is identified as a cache hit when the similarity measure exceeds a threshold, and the cache entry is thereby identified as a cache hit notwithstanding differences in wording between the natural language prompt 202 that produced the cache entry and the subsequent natural language prompt 202.

In some examples, identification of a cache hit by the VR platform server 102 further requires that the metadata of the cache entry be compatible with the target virtual object 216 identified from the scene context supplied with the subsequent natural language prompt 202, such that the logical actions referenced by the nodes of the cached circuit graph 428 are supported by attributes, methods, or sub-objects of the target virtual object 216 and the logical actions referenced by the nodes of the cached circuit graph 428 are defined in the API definition 214 applicable to the subsequent natural language prompt 202. In some examples, when more than one cache entry satisfies the match criterion, the VR platform server 102 selects the cache entry for which the similarity measure is highest, or applies a tie-breaking rule based on recency of the cache entry, frequency of prior reuse of the cache entry, or compatibility of the metadata with the target virtual object 216.

In some examples, upon identification of a cache hit, the VR platform server 102 retrieves the cached circuit graph 428 from the content library 108 and applies the cached circuit graph 428 to the target virtual object 216 identified from the scene context supplied with the subsequent natural language prompt 202, in place of invoking the generative model 204 and the compiler 208 to produce a freshly generated circuit graph 428. In some examples, application of the cached circuit graph 428 to the target virtual object 216 includes rebinding nodes of the cached circuit graph 428 that reference attributes, methods, or sub-objects of a prior target virtual object 216 to corresponding attributes, methods, or sub-objects of the target virtual object 216 identified from the subsequent scene context, such that the cached circuit graph 428 operates on the target virtual object 216 identified from the subsequent scene context notwithstanding that the cached circuit graph 428 was produced for a prior target virtual object 216.

In some examples, when no cache entry in the content library 108 satisfies the match criterion, the VR platform server 102 treats the subsequent natural language prompt 202 as a cache miss and proceeds to invoke the generative model 204 and the compiler 208 to generate a new circuit graph 428, and stores the new circuit graph 428 in the content library 108 as an additional cache entry with associated metadata derived from the subsequent natural language prompt 202, the scene context, the target virtual object 216, and the API definition 214, such that subsequent natural language prompts 202 describing an equivalent behavior are served from the additional cache entry without reinvocation of the generative model 204.

In some examples, the generative model 204 is hosted remotely from the Maker AI Agent 106 of the VR platform server 102, and the generative AI workflow 104 invokes the generative model 204 through an application programming interface (API) exposed by the remote host. For example, the generative model 204 is implemented as a proprietary large language model accessible via an API endpoint provided by a third-party inference provider, such that the VR platform server 102 is not required to host the weights or inference infrastructure of the generative model 204 locally. In some examples, the Maker AI Agent 106 assembles an API request that includes the natural language prompt 202, the target virtual object 216, one or more context virtual objects 212, and the API definition 214 as contextual inputs, and transmits the API request to the remote host over a network using a network interface 606 of the VR platform server 102.

In some examples, the API request is transmitted to the remote host using a transport protocol such as HTTPS, with the contextual inputs serialized into a structured payload, such as a JSON body, that conforms to a request schema exposed by the API of the remote host. In some examples, the API request includes authentication credentials, such as an API key or bearer token, by which the remote host authorizes the invocation, and includes model selection parameters that identify a particular architecture of the generative model 204 to be invoked, such as OpenAI GPT4.1, OpenAI o4-mini, DeepSeek R1, Meta Llama 3, or Qwen3.

In some examples, the remote host executes inference using the generative model 204 against the contextual inputs contained in the API request and returns, in an API response, the text-based logic instructions 206 emitted by the generative model 204, and the Maker AI Agent 106 extracts the text-based logic instructions 206 from the API response and provides the text-based logic instructions 206 to the compiler 208 of the VR platform server 102 for conversion to block-based logic instructions 210. In some examples, the use of the API to invoke the generative model 204 hosted remotely from the Maker AI Agent 106 permits the architecture of the generative model 204 to be substituted, upgraded, or scaled independently of the VR platform server 102 by reconfiguring the API endpoint and the model selection parameters referenced by the Maker AI Agent 106.

FIG. 5A, FIG. 5B, and FIG. 5C illustrate an example use case of the maker AI system, according to some examples. In the example use case, a user issues a natural language prompt to add logic to a target virtual object 510 within a virtual environment 502. In response, the maker AI system 100 (of FIG. 1) generates block-based logic instructions 210 (of FIG. 2) responsive to the natural language prompt, and the maker AI system 100 confirms application of the block-based logic instructions 210 to the target virtual object 510.

In some examples, the virtual environment 502 is presented to the user by the VR user interface device 112 (of FIG. 1), and includes a target virtual object 510 that is a tiny bot and one or more context virtual objects 212 (of FIG. 2) that are present within the virtual environment 502, such as walls, a floor, a window, and additional virtual objects positioned within the room of the virtual environment 502. The user issues a natural language prompt via the VR user interface device 112 that describes a behavior to be applied to the target virtual object 510, and the VR user interface device 112 displays a confirmation message 512 within the virtual environment 502 that reproduces the content of the natural language prompt as interpreted by the Maker AI Agent 106 (of FIG. 1), namely “LET'S MAKE THE TINY BOT FOLLOW YOU AROUND.”

In some examples, the Maker AI Agent 106 identifies the target virtual object 510 from among the context virtual objects 212 based on cues associated with the natural language prompt, such as selection of the target virtual object 510 by the user within the virtual environment 502, a gaze location of the user directed at the target virtual object 510, or a pointer of the user directed at the target virtual object 510, and the confirmation message 512 is displayed in association with the target virtual object 510 to indicate to the user that the target virtual object 510 has been identified as the target of the natural language prompt.

In some examples, upon confirmation of the natural language prompt by the user, the VR user interface device 112 uploads a scene context to the VR platform server 102 (of FIG. 1), the scene context including data defining the target virtual object 510 and the context virtual objects 212 present within the virtual environment 502, and the VR platform server 102 invokes the generative model 204 (of FIG. 2) with the natural language prompt, the target virtual object 510, the context virtual objects 212, and the API definition 214 (of FIG. 2) as contextual inputs.

In some examples, while the generative model 204 generates text-based logic instructions 206 (of FIG. 2) and the compiler 208 (of FIG. 2) converts the text-based logic instructions 206 into block-based logic instructions 210 representing a circuit graph 428 (of FIG. 4) that implements the behavior described by the natural language prompt, the VR user interface device 112 displays a status message 518 within the virtual environment 502 in association with the target virtual object 510. As an example, the status message 518 reciting “GENERATING CIRCUITS: MAKE THIS TINY BOT FOLLOW THE USER AROUND AUTOMATICALLY . . . ” indicating to the user that generation of the block-based logic instructions 210 by the generative model 204 and the compiler 208 is in progress.

In some examples, upon completion of generation of the block-based logic instructions 210 and application of the block-based logic instructions 210 to the target virtual object 510 within the virtual environment 502, such that the target virtual object 510 is bound to the block-based logic instructions 210 and the triggering events of the block-based logic instructions 210 are registered with event sources of the target virtual object 510 and the context virtual objects 212, the VR user interface device 112 displays a status message 524 within the virtual environment 502. The status message 524 is displayed in association with the target virtual object 510. As an example, the status message 524 recites “THE TINY BOT IS NOW SET UP TO FOLLOW YOU AROUND! LET ME KNOW IF THERE'S ANYTHING ELSE YOU'D LIKE TO DO” to indicate to the user that the block-based logic instructions 210 have been applied to the target virtual object 510 and to invite the user to issue a further natural language prompt to update or extend the logic applied to the target virtual object 510 in accordance with blocks 316 and 318 of the method 300 (of FIG. 3).

### Computing Device Architecture

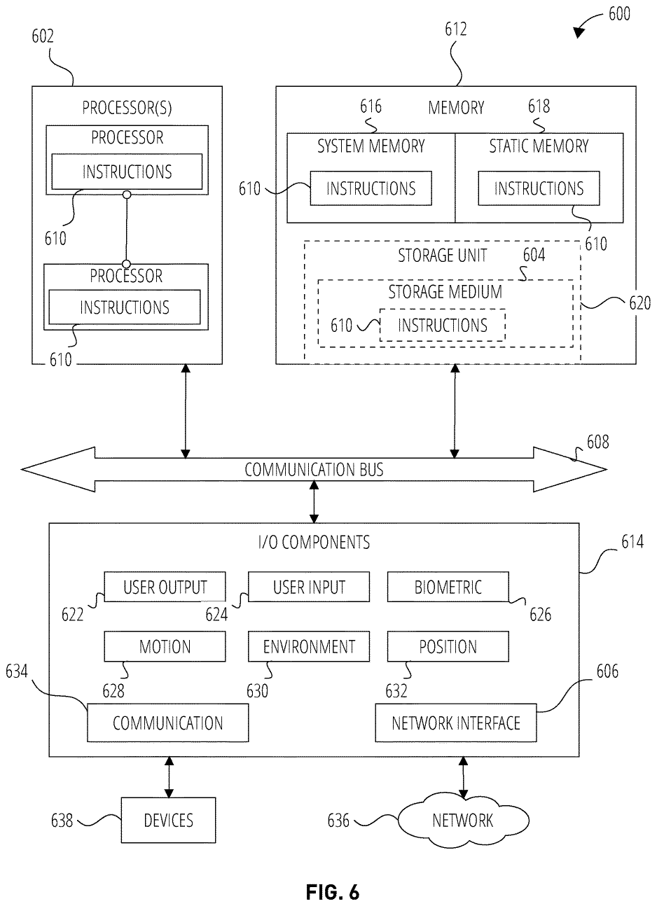

FIG. 6 is a block diagram that illustrates aspects of a computing device 600 appropriate for use to create a computing system as described in the present disclosure, according to some examples. While multiple different types of computing devices may be used to create the computing system (e.g., server computing devices, desktop computing devices, laptop computing devices, console computing devices (e.g., Xbox, PlayStation, Switch, etc.), mobile computing devices (e.g., a smartphone, tablet, etc.), one or more computing devices of a cloud computing system, etc.), the example computing device 600 describes various elements that are common to many different types of computing devices. While FIG. 6 is described with reference to a computing device that is implemented as a device on a network, the description below is applicable to servers, personal computers, mobile phones, smartphones, tablet computers, embedded computing devices, and other devices that may be used to implement portions of examples of the present disclosure. Some examples of a computing device may be implemented in or may include an application-specific integrated circuit (ASIC), a field-programmable gate array (FPGA), or other customized device. The computing device 600 may include, but is not limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing instructions, sequentially or otherwise, that specify actions to be taken by the computing device 600. Further, while a single computing device 600 is illustrated, the term “computing device” shall also be taken to include a collection of computing devices that individually or jointly execute instructions to perform any one or more of the methodologies discussed herein. Moreover, those of ordinary skill in the art and others will recognize that the computing device 600 may be any one of any number of currently available or yet to be developed devices.

In its most basic configuration, the computing device 600 includes at least one processor 602 and a system memory 612 connected by a communication bus 608. Depending on the exact configuration and type of device, the system memory 612 may be volatile or nonvolatile memory, such as read-only memory (“ROM”), random access memory (“RAM”), EEPROM, flash memory, or similar memory technology. Those of ordinary skill in the art and others will recognize that system memory 612 typically stores data and/or program modules that are immediately accessible to and/or currently being operated on by the processor 602. In this regard, the processor 602 may serve as a computational center of the computing device 600 by supporting the execution of instructions. The processor 602 may include one or more data processors, such as a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), a Quantum Processing Unit (QPU), a Tensor Processing Unit (TPU), a Neural Processing Unit (NPU), a Field Programmable Gate Array (FPGA), another processor, or any suitable combination thereof. The processor 602 may include multi-core processors comprising two or more independent cores, which may be homogeneous or heterogeneous. The processor 602 may also encompass a distributed architecture in which multiple processors are interconnected to perform tasks in a coordinated manner, including cluster computing, grid computing, and cloud computing infrastructures. The processor 602 may be embedded in a device to control specific functions of that device, may be part of a larger system such as a server in a data center, or may be virtualized in a software-defined infrastructure in which the processor's functions are emulated in software.

As further illustrated in FIG. 6, the computing device 600 may include a network interface 606 comprising one or more components for communicating with other devices over a network. Examples of the present disclosure may access basic services that utilize the network interface 606 to perform communications using common network protocols. The network interface 606 may also include a wireless network interface configured to communicate via one or more wireless communication protocols, such as Wi-Fi, 2G, 3G, LTE, WiMAX, Bluetooth, Bluetooth low energy, and/or the like. As will be appreciated by one of ordinary skill in the art, the network interface 606 illustrated in FIG. 6 may represent one or more wireless interfaces or physical communication interfaces described and illustrated above with respect to particular components of the computing device 600. The network interface 606 may further include wired communication components, cellular communication components, Near Field Communication (NFC) components, and other communication components to provide communication via other modalities, and may include components operable to detect identifiers such as Radio Frequency Identification (RFID) tag reader components, NFC smart tag detection components, optical reader components (e.g., an optical sensor to detect one-dimensional bar codes such as Universal Product Code (UPC) bar codes, multi-dimensional bar codes such as Quick Response (QR) code, Aztec code, Data Matrix, Dataglyph™, MaxiCode, PDF417, Ultra Code, UCC RSS-2D bar code, and other optical codes), or acoustic detection components (e.g., microphones to identify tagged audio signals). In addition, a variety of information may be derived via the network interface 606, such as location via Internet Protocol (IP) geolocation, location via Wi-Fi signal triangulation, and location via detecting an NFC beacon signal that may indicate a particular location.

In the example depicted in FIG. 6, the computing device 600 also includes a storage medium 604. However, services may be accessed using a computing device that does not include means for persisting data to a local storage medium. Therefore, the storage medium 604 depicted in FIG. 6 is represented with a dashed line to indicate that the storage medium 604 is optional. In any event, the storage medium 604 may be volatile or non-volatile, removable or nonremovable, implemented using any technology capable of storing information such as, but not limited to, a hard drive, solid state drive, CD ROM, DVD, or other disk storage, magnetic cassettes, magnetic tape, magnetic disk storage, and/or the like. The storage medium 604 may include non-volatile memory, including by way of example semiconductor memory devices (e.g., erasable programmable read-only memory (EPROM), electrically erasable programmable read-only memory (EEPROM), Field-Programmable Gate Arrays (FPGA), flash memory devices, Solid State Drives (SSD), and Non-Volatile Memory Express (NVMe) devices); magnetic disks such as internal hard disks and removable disks; magneto-optical disks; and CD-ROM, DVD-ROM, Blu-ray Discs, and Ultra HD Blu-ray discs. In addition, the storage medium 604 may refer to cloud storage services, Network Attached Storage (NAS), Storage Area Networks (SAN), and object storage devices.

The system memory 612 and storage medium 604 may store one or more sets of instructions 610 and data structures (e.g., software) embodying or used by any one or more of the methodologies or functions described herein. These instructions 610, when executed by the processors 602, cause various operations to implement the disclosed examples. The instructions 610 may also reside, completely or partially, within the system memory 612, within the storage medium 604, within at least one cache memory of the processors 602, or any suitable combination thereof, during execution thereof by the computing device 600.

Suitable implementations of computing devices that include a processor 602, system memory 612, communication bus 608, storage medium 604, and network interface 606 are known and commercially available. For ease of illustration and because it is not important for an understanding of the claimed subject matter, FIG. 6 does not show some of the typical components of many computing devices. In this regard, the computing device 600 may include input devices, such as a keyboard, keypad, mouse, microphone, touch input device, touch screen, tablet, and/or the like. Such input devices may be coupled to the computing device 600 by wired or wireless connections including RF, infrared, serial, parallel, Bluetooth, Bluetooth low energy, USB, or other suitable connection protocols using wireless or physical connections. Similarly, the computing device 600 may also include output devices such as a display, speakers, printer, etc. Since these devices are well known in the art, they are not illustrated or described further herein.

For example, the instructions 610 may cause the computing device 600 to execute any one or more of the methods described herein. The instructions 610 transform the general, non-programmed computing device 600 into a particular computing device 600 programmed to carry out the described and illustrated functions in the manner described. The computing device 600 may operate as a standalone device or may be coupled (e.g., networked) to other machines. In a networked deployment, the computing device 600 may operate in the capacity of a server machine or a client machine in a server-client network environment, or as a peer machine in a peer-to-peer (or distributed) network environment. The computing device 600 may include, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 610, sequentially or otherwise, that specify actions to be taken by the computing device 600. Further, while a single computing device 600 is illustrated, the term “machine” shall also be taken to include a collection of machines that individually or jointly execute the instructions 610 to perform any one or more of the methodologies discussed herein. The computing device 600, for example, may include the VR user interface device 112 or any one of multiple server devices forming part of the VR platform server 102. In some examples, the computing device 600 may also include both client and server systems, with certain operations of a particular method or algorithm being performed on the server-side and with certain operations of the method or algorithm being performed on the client-side.

In some examples, the computing device 600 may include one or more processors 602, one or more memories 612, and input/output (I/O) components 614, which may be configured to communicate with each other via a communication bus 608.

In some examples, the memory 612 includes a system memory 616, a static memory 618, and a storage unit 620, both accessible to the processor 602 via the communication bus 608. The system memory 616, the static memory 618, and storage unit 620 store the instructions 610 embodying any one or more of the methodologies or functions described herein. The instructions 610 may also reside, completely or partially, within the system memory 616, within the static memory 618, within storage medium 604 within the storage unit 620, within at least one of the processors 602 (e.g., within the processor's cache memory), or any suitable combination thereof, during execution thereof by the computing device 600.

In some examples, the I/O components 614 may include a wide variety of components to receive input, provide output, produce output, transmit information, exchange information, capture measurements, and so on. The specific I/O components 614 that are included in a particular machine will depend on the type of machine. For example, portable machines such as mobile phones may include a touch input device or other such input mechanisms, while a headless server machine will likely not include such a touch input device. It will be appreciated that the I/O components 614 may include many other components that are not shown in FIG. 6. In various examples, the I/O components 614 may include user output components 622 and user input components 624. The user output components 622 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 624 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 614 may include biometric components 626, motion components 628, environmental components 630, or position components 632, among a wide array of other components. For example, the biometric components 626 include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The biometric components may include a brain-machine interface (BMI) system that allows communication between the brain and an external device or machine. This may be achieved by recording brain activity data, translating this data into a format that can be understood by a computer, and then using the resulting signals to control the device or machine.

In some examples, example types of BMI technologies can include:
Electroencephalography (EEG) based BMIs, which record electrical activity in the brain using electrodes placed on the scalp.
Invasive BMIs, which use electrodes that are surgically implanted into the brain.
Optogenetics BMIs, which use light to control the activity of specific nerve cells in the brain.

Any biometric data collected by the biometric components is captured and stored only with user approval and deleted on user request, and in accordance with applicable laws. Further, such biometric data may be used for very limited purposes, such as identification verification. To ensure limited and authorized use of biometric information and other personally identifiable information (PII), access to this data is restricted to authorized personnel only, if at all. Any use of biometric data may be strictly limited to identification verification purposes, and the data is not shared or sold to any third party without the explicit consent of the user. In addition, appropriate technical and organizational measures are implemented to ensure the security and confidentiality of this sensitive information.

In some examples, the use and deletion of the biometric data collected by the biometric components is controlled by a compliance application that executes on the computing device 600. The compliance application facilitates compliance by the VR platform server 102 (of FIG. 1) and the VR user interface device 112 (of FIG. 1) with data privacy and other regulations, including, for example, the California Consumer Privacy Act (CCPA), General Data Protection Regulation (GDPR), and Digital Services Act (DSA). The compliance application includes several components that address data privacy, protection, and user rights, ensuring a secure environment for user data. A data collection and storage component securely handles user data, using encryption and enforcing data retention policies. A data access and processing component provides controlled access to user data, ensuring compliant data processing and maintaining an audit trail. A data subject rights management component facilitates user rights requests in accordance with privacy regulations, while the data breach detection and response component detects and responds to data breaches in a timely and compliant manner. The compliance application also incorporates opt-in/opt-out management and privacy controls across any digital interaction systems that the VR platform server 102 or the VR user interface device 112 may be coupled to, empowering users to manage their data preferences. The compliance application is designed to handle sensitive data by obtaining explicit consent and implementing strict access controls in accordance with all applicable laws.

In some examples, the motion components 628 include acceleration sensor components (e.g., accelerometer), gravitation sensor components, rotation sensor components (e.g., gyroscope).

The environmental components 630 include, for example, one or more cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment.

In some examples, with respect to cameras, the VR user interface device 112 may have a camera system comprising, for example, front cameras on a front surface of the VR user interface device 112 and rear cameras on a rear surface of the VR user interface device 112. The front cameras may, for example, be used to capture still images and video of a user of the VR user interface device 112 (e.g., “selfies”), which may then be modified with digital effect data (e.g., filters) described above. The rear cameras may, for example, be used to capture still images and videos in a more traditional camera mode, with these images similarly being modified with digital effect data. In addition to front and rear cameras, the VR user interface device 112 may also include a 360° camera for capturing 360° photographs and videos.

In some examples, the camera system of the VR user interface device 112 may be equipped with advanced multi-camera configurations. This may include dual rear cameras, which might consist of a primary camera for general photography and a depth-sensing camera for capturing detailed depth information in a scene. This depth information can be used for various purposes, such as creating a bokeh effect in portrait mode, where the subject is in sharp focus while the background is blurred. In addition to dual camera setups, the VR user interface device 112 may also feature triple, quad, or even penta-camera configurations on both the front and rear sides of the VR user interface device 112. These multiple camera systems may include a wide camera, an ultra-wide camera, a telephoto camera, a macro camera, and a depth sensor, for example.

In some examples, communication may be implemented using a wide variety of technologies. The I/O components 614 further include communication components 634 operable to couple the computing device 600 to a network 636 or devices 638 via respective couplings or connections. For example, the communication components 634 may include a network interface component or another suitable device to interface with the Network 636. In further examples, the communication components 634 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 638 may be another machine or any of a wide variety of peripheral devices (e.g., a peripheral device coupled via a USB).

In some examples, the communication components 634 may detect identifiers or include components operable to detect identifiers. For example, the communication components 634 may include Radio Frequency Identification (RFID) tag reader components, NFC smart tag detection components, optical reader components (e.g., an optical sensor to detect one-dimensional bar codes such as Universal Product Code (UPC) bar codes, multi-dimensional bar codes such as Quick Response (QR) code, Aztec code, Data Matrix, Dataglyph™, MaxiCode, PDF417, Ultra Code, UCC RSS-2D bar code, and other optical codes), or acoustic detection components (e.g., microphones to identify tagged audio signals). In addition, a variety of information may be derived via the communication components 634, such as location via Internet Protocol (IP) geolocation, location via Wi-Fi® signal triangulation, location via detecting an NFC beacon signal that may indicate a particular location, and so forth.

In some examples, the various memories (e.g., system memory 616, static memory 618, and memory of the Processor 602) and storage unit 620 may store one or more sets of instructions and data structures (e.g., software) embodying or used by any one or more of the methodologies or functions described herein. These instructions (e.g., the instructions 610), when executed by the processors 602, cause various operations to implement the disclosed examples.

In some examples, the instructions 610 may be transmitted or received over the network 636, using a transmission medium, via a network interface device (e.g., a network interface component included in the communication components 634) and using any one of several well-known transfer protocols (e.g., hypertext transfer protocol (HTTP)). Similarly, the instructions 610 may be transmitted or received using a transmission medium via a coupling (e.g., a peer-to-peer coupling) to the devices 638.

As used in this disclosure, phrases of the form “at least one of an A, a B, or a C,” “at least one of A, B, or C,” “at least one of A, B, and C,” and the like, should be interpreted to select at least one from the group that comprises “A, B, and C.” Unless explicitly stated otherwise in connection with a particular instance in this disclosure, this manner of phrasing does not mean “at least one of A, at least one of B, and at least one of C.” As used in this disclosure, the example “at least one of an A, a B, or a C,” would cover any of the following selections: {A}, {B}, {C}, {A, B}, {A, C}, {B, C}, and {A, B, C}.

Unless the context clearly requires otherwise, throughout the description and the claims, the words “comprise,” “comprising,” and the like are to be construed in an inclusive sense, as opposed to an exclusive or exhaustive sense, e.g., in the sense of “including, but not limited to.”

As used herein, the terms “connected,” “coupled,” or any variant thereof means any connection or coupling, either direct or indirect, between two or more elements; the coupling or connection between the elements can be physical, logical, or a combination thereof.

Additionally, the words “herein,” “above,” “below,” and words of similar import, when used in this application, refer to this application as a whole and not to any portions of this application. Where the context permits, words using the singular or plural number may also include the plural or singular number respectively.

The word “or” in reference to a list of two or more items, covers all the following interpretations of the word: any one of the items in the list, all the items in the list, and any combination of the items in the list. Likewise, the term “and/or” in reference to a list of two or more items, covers all the following interpretations of the word: any one of the items in the list, all the items in the list, and any combination of the items in the list.

The various features, operations, or processes described herein may be used independently of one another, or may be combined in various ways. All possible combinations and sub-combinations are intended to fall within the scope of this disclosure. In addition, certain method or process blocks may be omitted in some implementations.

Although some examples, e.g., those depicted in the drawings, include a particular sequence of operations, the sequence may be altered without departing from the scope of the present disclosure. For example, some of the operations depicted may be performed in parallel or in a different sequence that does not materially affect the functions as described in the examples. In other examples, different components of an example device or system that implements an example method may perform functions at substantially the same time or in a specific sequence.

### Example Statements

Described implementations of the subject matter can include one or more features, alone or in combination as illustrated below by way of example.

Example 1 is a computer-implemented method of adjusting logic editable within a virtual environment, the method comprising: receiving, by a computing system, a natural language prompt to add logic to a target virtual object within the virtual environment; using, by the computing system, a generative model to generate text-based logic instructions based on the natural language prompt; converting, by the computing system, the text-based logic instructions to block-based logic instructions; and adding, by the computing system, the block-based logic instructions to the target virtual object within the virtual environment.

In Example 2, the subject matter of Example 1 includes, wherein using the generative model to generate the text-based logic instructions based on the natural language prompt includes providing at least a text-based application programming interface (API) definition as contextual input to the generative model.

In Example 3, the subject matter of any of Examples 1-2 includes, wherein using the generative model to generate the text-based logic instructions based on the natural language prompt includes providing at least a definition of the target virtual object as a contextual input to the generative model.

In Example 4, the subject matter of any of Examples 1-3 includes, wherein the definition of the target virtual object includes a container of virtual objects that are sub-objects of the target virtual object.

In Example 5, the subject matter of any of any of Examples 1-4 includes, wherein the text-based logic instructions include at least one manipulation of the target virtual object.

In Example 6, the subject matter of any of Examples 1-5 includes: receiving, by the computing system, a new natural language prompt to update the logic added to the target virtual object; and using, by the computing system, the generative model to generate updated text-based logic instructions based on the new natural language prompt and one or more of the block-based logic instructions or the text-based logic instructions.

In Example 7, the subject matter of any of Examples 1-6 includes: presenting, by the computing system, the block-based logic instructions to a user within the virtual environment; receiving, by the computing system, a manipulation of at least one block of the block-based logic instructions from the user within the virtual environment; and updating, by the computing system, the block-based logic instructions to include the at least one manipulated block.

In Example 8, the subject matter of any of Examples 1-7 includes, wherein the generative model is a large language model (LLM).

Example 9 is a computer-implemented method of applying user-editable logic to a virtual object within a virtual environment shared among a plurality of participating client devices, the method comprising: receiving, by a server system from a client device of the plurality of participating client devices, a prompt and a scene context associated with a runtime instance of the virtual environment presented by the client device, the scene context including data defining a target virtual object within the virtual environment; generating, by the server system, text-based logic instructions using a generative model based at least in part on the prompt and the scene context; compiling, by the server system, the text-based logic instructions into a circuit graph comprising a plurality of nodes corresponding to logical actions and edges identifying connections between the nodes; transmitting, by the server system, the circuit graph to the client device for binding to the target virtual object within the runtime instance of the virtual environment; receiving, by the server system from the client device, compiled code generated by the client device from the circuit graph, the compiled code being executable by a runtime; and executing, by the server system, the compiled code under a server authority that maintains a canonical game state for the virtual environment shared among the plurality of participating client devices, such that mutations of the canonical game state resulting from execution of the compiled code are propagated by the server system to the plurality of participating client devices.

In Example 10, the subject matter of Example 9 includes, wherein the scene context further includes data defining one or more context virtual objects present within a scene of the virtual environment together with the target virtual object, and wherein generating the text-based logic instructions includes providing the one or more context virtual objects as contextual input to the generative model.

In Example 11, the subject matter of any of Examples 9-10 includes, wherein compiling the text-based logic instructions into the circuit graph includes restricting the nodes of the circuit graph to logical actions defined by a text-based application programming interface (API) definition identifying function signatures of logical actions supported by the server system.

In Example 12, the subject matter of any of Examples 9-11 includes, wherein the compiled code comprises intermediate language instructions executable by a Mono runtime.

In Example 13, the subject matter of any of Examples 9-12 includes: receiving, by the server system from the client device, a manipulation of at least one node of the circuit graph performed by a user of the client device within the virtual environment using a block-manipulation interface rendered within the runtime instance of the virtual environment; and receiving, by the server system from the client device, updated compiled code generated by the client device from the circuit graph as modified by the manipulation.

In Example 14, the subject matter of any of Examples 9-13 includes, wherein executing the compiled code under the server authority comprises dispatching, by the server authority, compiled routines corresponding to nodes of the circuit graph in response to occurrences of triggering events registered for the nodes of the circuit graph, the triggering events being propagated from the client device to the server system.

In Example 15, the subject matter of any of Examples 9-14 includes, wherein executing the compiled code under the server authority is confined to invocations of logical actions defined in a text-based application programming interface (API) definition exposed by the server system, such that execution by the server authority is restricted to signed logical actions implemented by the server system.

In Example 16, the subject matter of any of Examples 9-15 includes: storing, by the server system, the circuit graph in a content library as a cache entry, the cache entry including metadata comprising a representation of the prompt; receiving, by the server system from a second client device of the plurality of participating client devices, a subsequent prompt and a subsequent scene context associated with a runtime instance of the virtual environment presented by the second client device, the subsequent scene context including data defining a subsequent target virtual object; identifying, by the server system, the cache entry as a cache hit based on a match criterion evaluated between the representation of the prompt in the metadata of the cache entry and a representation of the subsequent prompt; and in response to identifying the cache hit, retrieving the circuit graph from the cache entry and transmitting the circuit graph to the second client device for binding to the subsequent target virtual object, in place of invoking the generative model to generate text-based logic instructions from the subsequent prompt.

In Example 17, the subject matter of any of Examples 9-16 includes, wherein the representation of the prompt in the metadata of the cache entry comprises a semantic embedding of the prompt, and wherein the match criterion comprises a similarity measure between the semantic embedding of the prompt and a semantic embedding of the subsequent prompt exceeding a threshold.

In Example 18, the subject matter of any of Examples 9-17 includes, wherein retrieving the circuit graph from the cache entry includes rebinding nodes of the circuit graph that reference attributes, methods, or sub-objects of the target virtual object to corresponding attributes, methods, or sub-objects of the subsequent target virtual object.

Example 19 is an apparatus comprising means to implement any of Examples 1-18.

Example 20 is a system to implement any of Examples 1-18.

Example 21 is at least one machine-readable medium including instructions that, when executed by processing circuitry, cause the processing circuitry to perform operations to implement any of Examples 1-18.

### Term Examples

“Carrier signal” may include, for example, any intangible medium that can store, encoding, or carrying instructions for execution by the machine and includes digital or analog communications signals or other intangible media to facilitate communication of such instructions. Instructions may be transmitted or received over a network using a transmission medium via a network interface device.

“Client device” may include, for example, any machine that interfaces to a network to obtain resources from one or more server systems or other client devices. A client device may be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user may use to access a network.

“Component” may include, for example, a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various examples, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application-specific integrated circuit (ASIC). A hardware component may also include programmable logic or circuitry that is temporarily configured by software to perform certain operations. For example, a hardware component may include software executed by a general-purpose processor or other programmable processors. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component”(or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” may refer to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some examples, the processors or processor-implemented components may be located in a single geographic location (e.g., within a home environment, an office environment, or a server farm). In other examples, the processors or processor-implemented components may be distributed across a number of geographic locations.

“Computer-readable medium” may include, for example, both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

“Machine storage medium and machine storage media” may include, for example, a single or multiple storage devices and media (e.g., a centralized or distributed database, and associated caches and servers) that store executable instructions, routines, and data. The term shall accordingly be taken to include, but not be limited to, solid-state memories, and optical and magnetic media, including memory internal or external to processors. Specific examples of machine-storage media, computer-storage media, and device-storage media include non-volatile memory, including by way of example semiconductor memory devices, e.g., erasable programmable read-only memory (EPROM), electrically erasable programmable read-only memory (EEPROM), Field-Programmable Gate Arrays (FPGA), flash memory devices, Solid State Drives (SSD), and Non-Volatile Memory Express (NVMe) devices; magnetic disks such as internal hard disks and removable disks; magneto-optical disks; and CD-ROM, DVD-ROM, Blu-ray Discs, and Ultra HD Blu-ray discs. In addition, machine storage medium may also refer to cloud storage services, Network Attached Storage (NAS), Storage Area Networks (SAN), and object storage devices. The terms “machine-storage medium,” “device-storage medium,” “computer-storage medium” mean the same thing and may be used interchangeably in this disclosure. The terms “machine-storage medium,” “computer-storage medium,” and “device-storage medium” specifically exclude carrier waves, modulated data signals, and other such media, at least some of which are covered under the term “signal medium.”

“Network” may include, for example, one or more portions of a network that may be an ad hoc network, an intranet, an extranet, a Virtual Private Network (VPN), a Local Area Network (LAN), a Wireless LAN (WLAN), a Wide Area Network (WAN), a Wireless WAN (WWAN), a Metropolitan Area Network (MAN), the Internet, a portion of the Internet, a portion of the Public Switched Telephone Network (PSTN), a Voice over IP (VoIP) network, a cellular telephone network, a 5G™ network, a wireless network, a Wi-Fi® network, a Wi-Fi 6® network, a Li-Fi network, a Zigbee® network, a Bluetooth® network, another type of network, or a combination of two or more such networks. For example, a network or a portion of a network may include a wireless or cellular network, and the coupling may be a Code Division Multiple Access (CDMA) connection, a Global System for Mobile communications (GSM) connection, or other types of cellular or wireless coupling. In this example, the coupling may implement any of a variety of types of data transfer technology, such as third Generation Partnership Project (3GPP) including 4G, fifth-generation wireless (5G) networks, Universal Mobile Telecommunications System (UMTS), High Speed Packet Access (HSPA), Long Term Evolution (LTE) standard, others defined by various standard-setting organizations, other long-range protocols, or other data transfer technology.

“Non-transitory computer-readable medium” may include, for example, a tangible medium that is capable of storing, encoding, or carrying the instructions for execution by a machine.

“Processor” may include, for example, data processors such as a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), a Quantum Processing Unit (QPU), a Tensor Processing Unit (TPU), a Neural Processing Unit (NPU), a Field Programmable Gate Array (FPGA), another processor, or any suitable combination thereof. The term “processor” may include multi-core processors that may comprise two or more independent processors (sometimes referred to as “cores”) that may execute instructions contemporaneously. These cores can be homogeneous (e.g., all cores are identical, as in multicore CPUs) or heterogeneous (e.g., cores are not identical, as in many modern GPUs and some CPUs). In addition, the term “processor” may also encompass systems with a distributed architecture, where multiple processors are interconnected to perform tasks in a coordinated manner. This includes cluster computing, grid computing, and cloud computing infrastructures. Furthermore, the processor may be embedded in a device to control specific functions of that device, such as in an embedded system, or it may be part of a larger system, such as a server in a data center. The processor may also be virtualized in a software-defined infrastructure, where the processor's functions are emulated in software.

“Signal medium” may include, for example, an intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a manner as to encode information in the signal. The terms “transmission medium” and “signal medium” mean the same thing and may be used interchangeably in this disclosure.

“User device” may include, for example, a device accessed, controlled or owned by a user and with which the user interacts perform an action, engagement or interaction on the user device, including an interaction with other users or computer systems.

What is claimed is:

1. A computer-implemented method comprising:
receiving, by a computing system, a natural language prompt to add logic to a target virtual object within a virtual environment;
using, by the computing system, a generative model to generate text-based logic instructions based on the natural language prompt;
converting, by the computing system, the text-based logic instructions to block-based logic instructions; and
adding, by the computing system, the block-based logic instructions to the target virtual object within the virtual environment.

2. The computer-implemented method of claim 1, wherein using the generative model to generate the text-based logic instructions based on the natural language prompt includes:
providing at least a text-based application programming interface (API) definition as contextual input to the generative model.

3. The computer-implemented method of claim 1, wherein using the generative model to generate the text-based logic instructions based on the natural language prompt includes:
providing at least a definition of the target virtual object as a contextual input to the generative model.

4. The computer-implemented method of claim 3, wherein the definition of the target virtual object includes a container of virtual objects that are sub-objects of the target virtual object.

5. The computer-implemented method of claim 3, wherein the text-based logic instructions include at least one manipulation of the target virtual object.

6. The computer-implemented method of claim 1, further comprising:
receiving, by the computing system, a new natural language prompt to update the logic added to the target virtual object; and
using, by the computing system, the generative model to generate updated text-based logic instructions based on the new natural language prompt and one or more of the block-based logic instructions or the text-based logic instructions.

7. The computer-implemented method of claim 1, further comprising:
presenting, by the computing system, the block-based logic instructions to a user within the virtual environment;
receiving, by the computing system, a manipulation of at least one block of the block-based logic instructions from the user within the virtual environment; and
updating, by the computing system, the block-based logic instructions to include the at least one manipulated block.

8. The computer-implemented method of claim 1, wherein the generative model is a large language model (LLM).

9. A machine comprising:
at least one processor; and
at least one memory storing instructions that, when executed by the at least processor, cause the machine to perform operations comprising:
receiving, by a computing system, a natural language prompt to add logic to a target virtual object within a virtual environment;
using, by the computing system, a generative model to generate text-based logic instructions based on the natural language prompt;
converting, by the computing system, the text-based logic instructions to block-based logic instructions; and
adding, by the computing system, the block-based logic instructions to the target virtual object within the virtual environment.

10. The machine of claim 9, wherein using the generative model to generate the text-based logic instructions based on the natural language prompt includes:
providing at least a text-based application programming interface (API) definition as contextual input to the generative model.

11. The machine of claim 9, wherein using the generative model to generate the text-based logic instructions based on the natural language prompt includes:
providing at least a definition of the target virtual object as a contextual input to the generative model.

12. The machine of claim 11, wherein the definition of the target virtual object includes a container of virtual objects that are sub-objects of the target virtual object.

13. The machine of claim 11, wherein the text-based logic instructions include at least one manipulation of the target virtual object.

14. The machine of claim 9, wherein the operations further comprise:
receiving, by the computing system, a new natural language prompt to update the logic added to the target virtual object; and
using, by the computing system, the generative model to generate updated text-based logic instructions based on the new natural language prompt and one or more of the block-based logic instructions or the text-based logic instructions.

15. The machine of claim 9, wherein the operations further comprise:
presenting, by the computing system, the block-based logic instructions to a user within the virtual environment;
receiving, by the computing system, a manipulation of at least one block of the block-based logic instructions from the user within the virtual environment; and
updating, by the computing system, the block-based logic instructions to include the at least one manipulated block.

16. The machine of claim 9, wherein the generative model is a large language model (LLM).

17. A machine storage medium, the machine storage medium including instructions that when executed by a machine, cause the machine to perform operations comprising:
receive, by a computing system, a natural language prompt to add logic to a target virtual object within a virtual environment;
using, by the computing system, a generative model to generate text-based logic instructions based on the natural language prompt;
convert, by the computing system, the text-based logic instructions to block-based logic instructions; and
add, by the computing system, the block-based logic instructions to the target virtual object within the virtual environment.

18. The machine storage medium of claim 17, wherein using the generative model to generate the text-based logic instructions based on the natural language prompt includes:
provide at least a text-based application programming interface (API) definition as contextual input to the generative model.

19. The machine storage medium of claim 17, wherein using the generative model to generate the text-based logic instructions based on the natural language prompt includes:
provide at least a definition of the target virtual object as a contextual input to the generative model.

20. The machine storage medium of claim 19, wherein the definition of the target virtual object includes a container of virtual objects that are sub-objects of the target virtual object.
